(19) United States
(12) Patent Application Publication
(10) Pub. No.: US 2011/0203226 A1
(43) Pub. Date: Aug. 25, 2011

(54) BREATHABLE INSULATION MATERIAL, DEVICE AND METHODS

(76) Inventor: Yael Bonneh, Kokhav Yair (IL)

(21) Appl. No.: 13/126,348

(22) PCT Filed: Oct. 27, 2009
(86) PCT No.: PCT/IL09/01002

§ 371 Date: Apr. 27, 2011

Related U.S. Application Data
(60) Provisional application No. 61/193,093, filed on Oct. 28, 2008.

(51) Int. Cl. B26D 7/27; B32B 5/26; B32B 5/06; B32B 21/02; B32B 1/02

(52) U.S. Cl. 53/396; 442/381; 442/382; 442/387; 442/389; 442/385; 428/35.2

(57) ABSTRACT

Provided is a three-ply insulating material which has combined properties to selected gases and vapors, thermal insulation, and humidity control. The device is built as a composite of three layers. The outer layer is made from breathable non woven composite. This layer is adjacent to and bonded to the middle layer, composed of high loft fibrous material with substantial weight to volume ratio, between about 2 to about 20 kg/m³. This middle layer is adjacent to a third layer of breathable non woven composite. The composite layered structure so designed forms an insulation blanket with thermal resistance of about 0.8 m² ° K/W and moisture vapor transmission rate (MVTR) between 50 and 10000 l/m²/hr.

### FIELD OF THE INVENTION

The invention pertains to the field of insulation systems for shipping and transport.

### BACKGROUND OF THE INVENTION

There are certain constraints involved in the shipping of many materials, amongst them limits on temperature, humidity, shock, electrostatic charge, electromagnetic radiation, oxygen levels, and so on. Often solutions for many of these constraints are partial, resulting in the loss of some value of the shipped material, or prohibitively expensive, restricting their use. Multiple concurrent constraints further restrict the possible solutions, such as when temperature excursions must be prevented but gas exchange allowed.

As an example of one such partial solution, US application 20060230778 “Insulated shipping container systems and methods thereof” provides an insulated shipping container for shipping temperature-sensitive goods and products using a heat transfer body set within a heat transfer cavity. The device has a support to set the heat transfer body at an interval from the inner walls of the cavity. The application claims methods for shipping temperature sensitive products and goods. It will be appreciated however that to solve the problems of thermal insulation, impermeable materials are used for the heat transfer body, as shown in FIG. 1. Thus the system does not allow gas transfer into and out of the container, which is in some cases (as in certain agricultural products) is necessary. Furthermore the humidity within the container volume is not controlled. This may prove catastrophic in certain cases, for instance in the shipping of agricultural products.

Similarly, US application 20090078699 “Insulated shipping container and method of making the same” provides an insulated shipping container for shipping temperature sensitive material e.g. certain biological materials. The application provides an insulated cover removably mounted on insulated insert to cover it from the top. However as in '778, the issue of gas permeability or ‘breathability’ of the device is not addressed. As will be appreciated by one skilled in the art, this can be a crucial consideration for shipping certain materials. Furthermore the humidity within the container volume is not controlled. This may prove catastrophic in certain cases, for instance in the shipping of agricultural products.

Thus it remains a long-felt need to provide means for thermally insulating cargo while at the same time controlling the humidity and gas transfer rate into and out of the container volume.

### SUMMARY

### BRIEF DESCRIPTION OF THE DRAWINGS

We disclose a thermal barrier capable of allowing gas and vapors transfer and humidity control. The device consists of three layers. The outer layer is made from breathable non woven composite. The middle layer comprises high loft fibrous material with substantial weight to volume ratio. The inner layer consists of breathable non woven composite. This composite layered structure forms an insulation blanket that can be produced in large planar sections or rolls that can be cut into different shapes to form insulated covers for goods in storage and transit.

It is within provision of the invention to provide a breathable insulation device (BID) adapted for protecting a payload contained within said BID, comprising:
a. an outer layer (201) comprising nonwoven composite;
b. a middle layer (202) bonded to said outer layer, said middle layer comprising high loft fibrous material;
c. an inner layer (203) bonded to said middle layer, said inner layer comprising nonwoven composite material;
wherein thermal resistance to temperature fluctuations, allowance of gas and vapor exchange, and humidity and gas concentration limits are simultaneously provided for said payload.

It is further within provision of the invention to provide the aforementioned BID wherein said outer and inner layers comprise materials selected from the group: cotton, ramie, jute, flax, stitch-bonded composites, hydroentangled nonwoven composites, Kunit materials, spunbond materials, and melt blown materials.

It is further within provision of the invention to provide the aforementioned BID wherein said middle layer comprises materials selected from the group: wood pulp fibers, thermoplastic fibers, and plastics.

It is further within provision of the invention to provide the aforementioned BID wherein the R-value of said BID is at least 0.8 m² ° K/W.

It is further within provision of the invention to provide the aforementioned BID wherein the moisture vapor transmission rate (MVTR) of said BID is between about 50 and about 10000 l/m²/hr.

It is further within provision of the invention to provide the aforementioned BID wherein the R-value of said BID is at least 0.8 m² ° K/W.

It is further within provision of the invention to provide the aforementioned BID wherein said middle layer high loft fibrous material has a volumetric density of between 2 km/m³ and 20 kg/m³.

It is further within provision of the invention to provide the aforementioned BID wherein said outer and inner layers are further provided with coatings selected from a group consisting of: hydrophobic coatings, hydrophilic coatings, hygroscopic coatings, and conductive coatings.

It is further within provision of the invention to provide the aforementioned BID wherein said BID takes a shape selected from the group consisting of pallet cover, sack, bag, liner, truck liner, container liner, and wall liner.

In order to understand the invention and to see how it may be implemented in practice, a plurality of embodiments is now described, by way of non-limiting example only, with reference to the accompanying drawings.

FIG. 1 illustrates an insulated container of prior art.

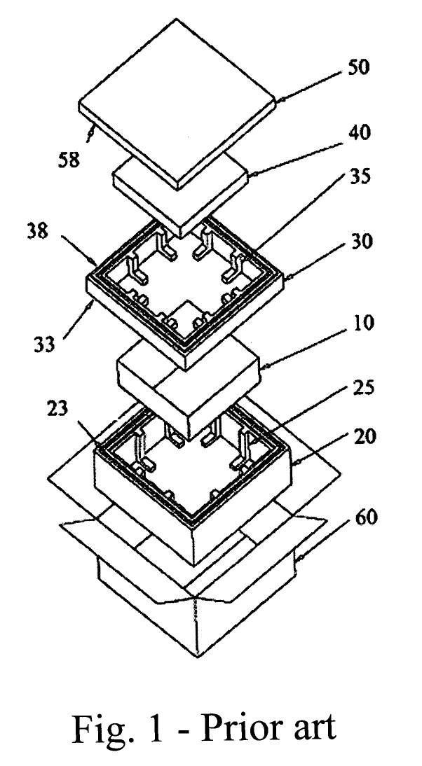

FIG. 2 illustrates another insulated container of prior art.

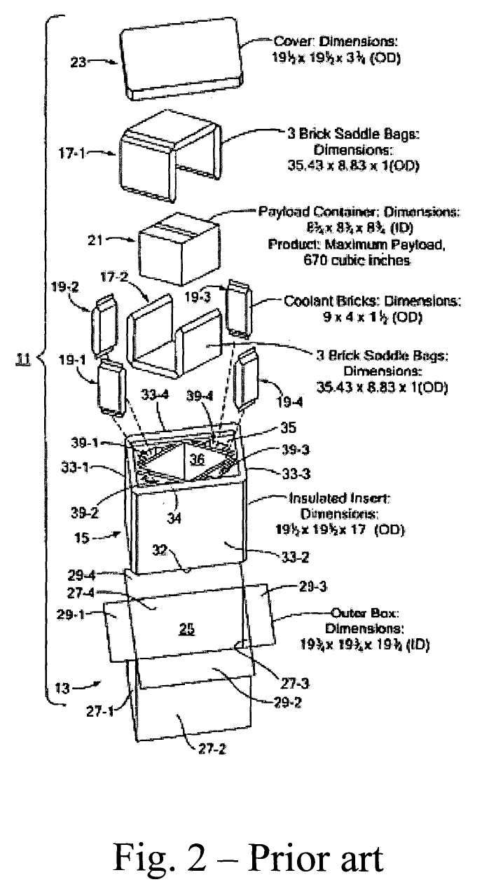

FIG. 3 illustrates the breathable insulation device of the current invention.

FIG. 4 illustrates a thermal insulation test of the device of the current invention.

FIG. 5 illustrates a thermal insulation test of the device of the current invention.

### DETAILED DESCRIPTION

The description is provided, alongside all chapters of the present invention, so as to enable any person skilled in the art to make use of said invention. The best modes contemplated by the inventor of carrying out this invention have been set forth herein. Various modifications, however, remain apparent to those skilled in the art, since the generic principles of the present invention have been defined specifically to provide means and methods for thermally insulated, semi-permeable shipping blankets.

The term “breathable insulation device (BID)” refers to the insulation device of the present invention.

The term “thermal resistance” hereinafter refers to the ability of a material to resist heat conduction. This may be measured by R-value (in ° Km²/W), thermal resistivity (in ° Km/W), or the like.

The term “diffusion coefficient” refers to the constant of proportionality between flux and gradient in Fick's law, (j=−D▾c). It may be measured e.g. in cm²/s.

The term “MVTR” refers to moisture vapor transmission ratio, as measured e.g. in l/m²/hr.

The term “O₂ transmission rate” refers to the rate at which oxygen travels through a given material, as measured e.g. in g/(m²×day), for example by means of the ASTM D3985 Standard.

The term “CO₂ transmission rate” refers to the rate at which carbon dioxide travels through a given material, as measured e.g. in g/(m²×day.

The term “N₂ transmission rate” refers to the rate at which nitrogen travels through a given material , as measured e.g. in g/(m²×day).

The term “permeability” refers to a measure of the ability of a porous material to transfer fluids, as measured for example in cm²/(Bar×day). The flux and permeability are related by j=PA▴p/d. where P is the permeability, A the area, ▴p the pressure drop across the material, and d the thickness of the material.

The term ‘payload’ refers to material contained within the insulation material (BID) of the current invention.

The term ‘payload area’ refers to the volume contained within the insulation material (BID) of the current invention.

We disclose a three-ply insulating material which has combined properties of permeability to selected gases and vapors, thermal insulation, and humidity control.

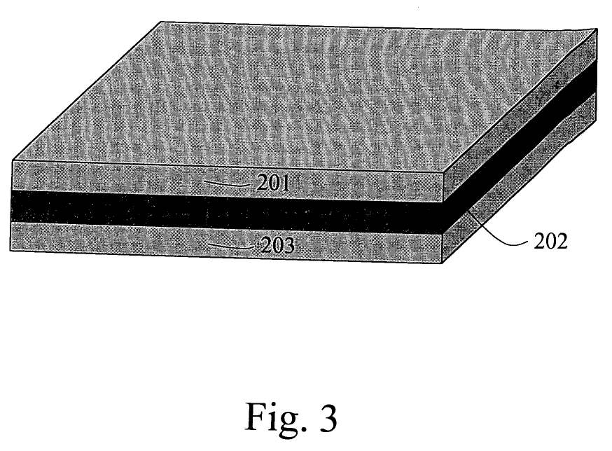

As shown schematically in FIG. 3, the device is built as a composite of three layers 201, 202, 203. The outer layer 201 is made from breathable non woven composite. This layer is adjacent to and bonded to the middle layer 202, composed of high loft fibrous material with substantial weight to volume ratio, between about 2 to about 20 kg/m³. This middle layer 202 is adjacent to the third inner layer 203 of breathable non woven composite. The composite layered structure so designed forms an insulation blanket that can be produced in large planar sections or rolls, that can subsequently be cut into different shapes to form insulated covers for goods in storage and transit.

The breathable thermal blanket (BID) is appropriate for applications requiring some level of gas permeability, high thermal resistance, and humidity control. The BID is a solution for many problem materials, including the shipping and/or storage of:
Foods, agricultural products (sensitive to high and low temperatures, high and low humidities, may require gas and vapor permeation)
Paints (phase separation may occur at low temperatures)
Pigments (phase separation)
Cosmetics (phase separation, waxes melt with heat)
Electronics (low humidity increases risk of electrostatic shock, cannot tolerate temperature extremes, humidity may damage certain components)
Explosives, fireworks, ammunition (sensitive to high temperatures, low humidity, electrostatic shock)
Lenses (crack upon freezing)
Waxes, candles (melt with heat)
Furniture (glues melt with heat, wood warps with humidity and temperature fluctuations)
Bulk chemicals (may be flammable, hygroscopic, temperature sensitive)
Pharmaceuticals
Perishables
Wine (corks may come out at low pressures, product quality affected by temperature fluctuations)

The inner and/or outer non woven composite layers are provided with some degree of hygroscopic action, such that they absorb humidity from their surroundings. By providing the BID with one or more hygroscopic layers, several goals are achieved:
1. The maximum humidity level within an area enclosed by BID is limited.
2. The minimum humidity level within an area enclosed by BID can be limited.

Both of these can be achieved since hygroscopic materials can also be used as humectants, as will be clear to one skilled in the art. For instance if a BID is exposed for an extended period of time to an atmosphere of 50% RH, it will reach equilibrium. Then the volume enclosed by this BID will remain at or near 50% relative humidity even when exposed to higher or lower ambient humidity levels, since increases or decreases in the surrounding RH will cause absorption or desorption, respectively, of moisture from the BID. This will continue until either the moisture content of the BID is exhausted (in a dry environment for a long enough time) or the absorptive capacity of the BID is reached (in a humid environment for a long enough time). It is within provision of the invention that the absorptive capacity and moisture content of the BID are large enough that RH can be maintained within 20% of a target value for 30 days.

Further control over the humidity of the payload contained within the BID can be had by means of controlling the hydrophilic and hydrophobic properties of the BID. For example, the outer layer of the BID can be made hydrophobic and the inner layer hydrophilic, to both prevent moisture from entering the payload and wick out any moisture that is contained in the payload volume.

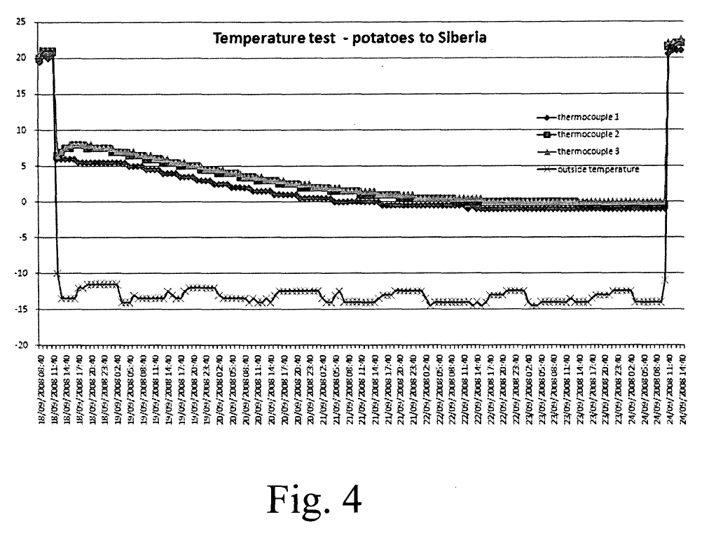

Similarly, due to the high thermal resistance of the BID, both minimum and maximum temperatures can be limited. It is within provision of the invention that the thermal resistance of the BID be characterized by an R-value of 0.8 m²K/W or greater. Due to this high thermal resistance, it is possible to ship goods that require high, low, or intermediate temperatures. It is within provision of the invention that the BID be used in conjunction with active temperature control, to reduce the heating and/or cooling load required of the active temperature control system. It is within provision of the invention that the BID be used in conjunction with passive cooling systems such as dry ice, liquid nitrogen or the like. These latter are particularly apt for use with the BID since the carbon dioxide or nitrogen vapors generated by such materials can escape the BID, preventing pressure buildup and humidity changes. The thermal protection provided by the system is shown in FIG. 4 in which temperature readings were taken within sacks of potatoes protected by the BID during their shipment to Siberia. As can be seen from the graph, despite exposure to external temperatures of about −14° C., the temperature within the sacks protected by the BID (as shown by readings of thermocouples 1, 2, 3) did not go below 0° C. From the slope of the temperature change an R-value may be calculated:

$$\dot{Q} = mc \frac{d T}{d t} = \frac{Δ T}{R} A \\ \to R = \frac{A Δ T}{mc \frac{d T}{d t}}$$

Using this formula and the values of the potato mass m, potato heat capacity c, container area A, and temperature difference ΔT , the R-value of the BID can be calculated as approximately 0.8 m² ° K/W.

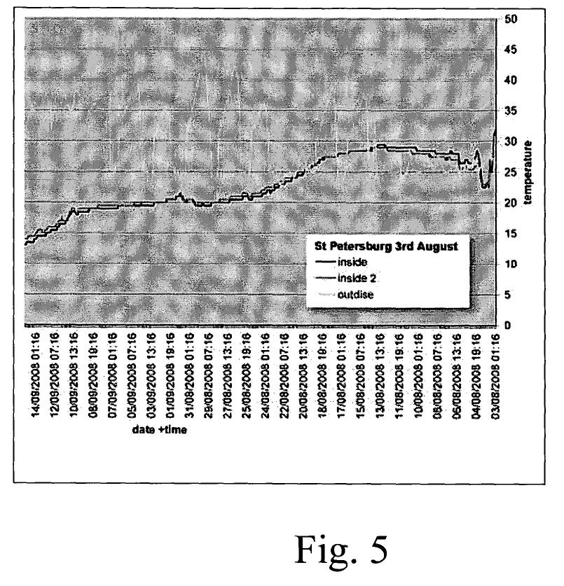

Reference is now made to FIG. 5. In this figure one can appreciate that the payload protected by the device is protected from daily temperature fluctuations, which will be amongst the most common large fluctuations encountered. As seen in the graph, daily fluctuations of up to 15° C. were suffered by the cargo container used in the experiment, but the contents underwent fluctuations of less than 1° C. per day during these periods.

As will be clear to one skilled in the art, conduction and radiation of heat through the device are greatly attenuated due to the highly insulating nature of the materials involved and their opacity to most normally encountered radiation, respectively. The only route left for heat conduction is convection, which is reduced to a minimum due to the extremely small pore size of the materials used. These pores allow for diffusion of gases to occur at a controlled rate that achieves an optimal tradeoff between diffusion and heat transfer.

The nonwoven composite may be felt, the material termed Kunit, cotton, stitch-bonded composites, hydroentangled nonwoven composites, the material termed Spunbond PP, PET , the material termed Meltblowen PP, kenaf, ramie, jute, flax, and any combination of these such as SMS or SMMS, and others as will be obvious to one skilled in the art. These layers may be further coated with hydrophilic, hydrophobic, hygroscopic, and electrically conductive coatings.

The high loft fibrous material of the middle layer can be composed of (by way of non-limiting example) wood pulp fibers, thermoplastic fibers, plastics, and others as will be obvious to one skilled in the art.

It is within provision of the invention to provide the BID in different thicknesses, depending on the requirements of the payload to protect, and depending on the outside temperature. It is within provision of the invention to achieve greater thickness by simply layering two BIDs to arrive at a six-layer sandwich structure, with approximately double the thermal resistance. Obviously three or more BIDs can also be layered if need be.

It is within provision that the BID be provided in sizes appropriate for European pallets, American pallets, 20 foot containers, 40 foot containers, truck cargo containers, and train boxcars. The embodiment for pallets can take the form for example of a cube, or a cube missing its bottom side.

A key provision of the BID is that it is a ‘breathable’ medium. Thus various gases and vapors can permeate the BID. It is within provision of the invention that the moisture vapor transmission rate (MVTR) of the BID range between 50 and 10000 l/m²/hr.

For agricultural products, the BID can be used from the time the product is being picked, for example in the form of sacks, bed liners, and the like. In the storage facility of an agricultural enterprise, the BID can be used likewise as sacks and liners, as well as flooring, wall, and ceiling covers, pallet coverings, container liners, and the like.

Agricultural products can be delivered for example in dry containers or airfreight pallets, which are provided with a BID inside the container that will both hold the temperature relatively constant and yet allow the gases from the fresh fruit vegetables to be forced out, due to the structure of the BID.

It is within provision of the invention that one or more layers of the BID be electrically conductive to some degree. By this means, the risk of electrostatic discharge (ESD) can be dramatically reduced. The control over minimum humidity the BID provides also helps to reduce the risk of ESD. Electronic conductivity will also have the beneficial effect of reducing the amount of radiation penetrating the BID, which can protect sensitive electronics and the like from various sources of radiation.

It is within provision of the invention that the BID satisfy simultaneous criteria of MVTR and R-value such that the MVTR is at least 50 l/m²/hr while the R-value is at least 0.8 m² ° K/W.

It is within provision of the invention to prevent condensation within the payload area, due to the water vapor permeability of the current invention in addition to the hygroscopic action of one or more layers of the device.

It is within provision of the invention to provide selective permeability, for example allowing oxygen to permeate the device but preventing CO₂ from permeating the device.

It is within provision of the invention to be produced in sizes appropriate for covering all standard European and American pallets, being produced in the form of rectangular prisms of the appropriate dimensions.

It is within provision of the invention to be produced in sizes appropriate for lining all standard European and American cargo container sizes, in the form of rectangular prisms of the appropriate dimensions.

It is within provision of the invention to be produced in customized sizes and shapes.

It is within provision of the invention to keep warm contents warm and cold contents cold, by means of the large level of thermal resistance attained by the device.

It will be appreciated by one skilled in the art that by reduced air conditioning requirements (heating and/or cooling), the cost of shipping goods contained within the BID can be appreciably decreased.

As an example of the utility of the device, the shipping of beet bulbs was undertaken using the BID. When shipped in standard cargo vessels on voyages taking several weeks to temperate climates, it was found that the beets began to sprout during the voyage, diminishing their vital capacity and ability to take root once planted. When shipped within the BID however, the better control over humidity levels prevented this en-route sprouting, allowing the beets bulbs to root more effectively once planted.

1-18. (canceled)

19. A breathable insulation device (BID) configured for protecting a payload contained within the BID, comprising:
a. an outer layer (201) comprising a nonwoven composite;
b. a middle layer (202) bonded to the outer layer, the middle layer comprising a high loft fibrous material;
c. an inner layer (203) bonded to the middle layer, the inner layer comprising a nonwoven composite material;
wherein thermal resistance to temperature fluctuations, allowance of gas and vapor exchange, and humidity and gas concentration limits are simultaneously provided for the payload.

20. The BID of claim 19, wherein the outer and inner layers each independently comprise materials selected from the group consisting of cotton, ramie, jute, flax, stitch-bonded composites, hydroentangled nonwoven composites, Kunit materials, spunbond materials, and melt blown materials.

21. The BID of claim 19, wherein the middle layer comprises materials selected from the group consisting of wood pulp fibers, thermoplastic fibers, and plastics.

22. The BID of claim 19, wherein the R-value of said BID is at least 0.8 m² ° K/W.

23. The BID of claim 19, wherein the moisture vapor transmission rate (MVTR) of the BID is between about 50 and about 10000 l/m² hr.

24. The BID of claim 23, wherein the R-value of the BID is at least 0.8 m² ° K/W.

25. The BID of claim 19, wherein the middle layer high loft fibrous material has a volumetric density of between 2 km/m³ and 20 kg/m³.

26. The BID of claim 19, wherein the outer and inner layers are further provided with coatings selected from a group consisting of hydrophobic coatings, hydrophilic coatings, hygroscopic coatings, and conductive coatings.

27. The BID of claim 19, wherein the BID takes a shape selected from the group consisting of pallet cover, sack, bag, liner, truck liner, container liner, and wall liner.

28. A method for protecting a payload comprising steps of:
a. providing a breathable insulation device (BID) configured for protecting a payload contained within the BID, the BID comprising:
i. an outer layer comprising nonwoven composite;
ii. a middle layer bonded to the outer layer, the middle layer comprising high loft fibrous material;
iii. an inner layer bonded to the middle layer, the inner layer comprising nonwoven composite material;
b. enveloping the payload within the BID;
whereby thermal resistance to temperature fluctuations, allowance of gas and vapor exchange, and humidity and gas concentration limits are simultaneously provided for the payload.

29. The method of claim 28, wherein the outer and inner layers comprise materials selected from the group consisting of cotton, ramie, jute, flax, stitch-bonded composites, hydroentangled nonwoven composites, Kunit materials, spunbond materials, and melt blown materials.

30. The method of claim 28, wherein the middle layer comprises materials selected from the group consisting of wood pulp fibers, thermoplastic fibers, plastics.

31. The method of claim 28, wherein the R-value of the BID is at least 0.8 m² ° K/W.

32. The method of claim 28, wherein the moisture vapor transmission rate (MVTR) of the BID is between about 50 and about 10000 l/m²/hr.

33. The method of claim 32, wherein the R-value of the BID is at least 0.8 m² ° K/W.

34. The method of claim 28, wherein the middle layer high loft fibrous material has a volumetric density of between 2 km/m³ and 20 kg/m³.

35. The method of claim 28, wherein the outer and inner layers are further provided with coatings selected from a group consisting of hydrophobic coatings, hydrophilic coatings, hygroscopic coatings, and conductive coatings.

36. The method of claim 28, wherein the BID takes a shape selected from the group consisting of pallet cover, sack, bag, liner, truck liner, container liner, and wall liner.
